(19) United States
(12) Patent Application Publication
(10) Pub. No.: US 2004/0167828 A1
(43) Pub. Date: Aug. 26, 2004

(54) Business method of providing products or services to a client in a graduated manner to achieve an end result

(76) Inventors: Frank H. Bria JR., Midlothian, VA (US); Keith C. Radley JR., Sandy, UT (US)

Correspondence Address: THORPE NORTH & WESTERN, LLP, P.O. 1219, Sandy, UT, 84091-1219, US

(21) Appl. No.: 10/667,272

(22) Filed: Sep. 16, 2003

Related U.S. Application Data
(60) Provisional application No. 60/411,325, filed on Sep. 17, 2002.

(51) Int. Cl. G06F 17/60

(52) U.S. Cl. 705/27

(57) ABSTRACT

A method of progressively advancing an internet customer, as well as any type of retail customer in a retail setting, through a series of customer interest level stages towards a highest stage is disclosed. The ultimate highest stage typically is represented by the purchase or acquisitions of goods or services from the internet website provider or retail provider. Initially, the method includes generating a website of interest accessible by one or more internet customers and then within that website, providing an initial webpage of interest for the internet customer. The first webpage includes a display of segregated content representing a choice of multiple stages of progressively higher interest level found on a separate webpage of interest associated with each stage of higher interest level, where the initial webpage includes a link to each webpage of interest. Next, the method provides for directing the internet customer to a customer selected stage of higher interest level via the link to the associated webpage of interest found on the initial webpage. The associated webpage typically includes content satisfying the internet customer's higher interest level at the next stage. In the retail setting, the customer would be directed from one area of the store to another or actually be able to view on a computer system or other self directed search system levels of interest similar to that described with respect to the webpages of interest. This would allow both types of consumers to achieve an ultimate goal, which is to make a purchase or selection from goods or services offered by the location of commerce.

Priority of application No. 60/411,325 filed Sep. 17, 2002 in the United States Patent Office is hereby claimed.

### BACKGROUND OF THE INVENTION

The present invention relates generally to the offer and sale of goods or services in an informative manner. More particularly, the present invention relates to offering information to increase a client's interest in offered goods or services and to direct the client to a final result.

Commerce of goods and services has a long history that often either advances technology or embraces it when beneficial. Commerce is the economic exchange of goods or services typically for other goods or services of comparable worth. Society has simplified the exchange of goods or services for value represented in the form of money. The use of money has allowed society to move away from a barter system to today's economic system of using money to represent the value of work done or goods sold, or the like, and then be exchanged for goods or services comparable to the worth of the money being given in kind. The barter system still survives in several forms, but the major economic model is the use of money as the foundation for representing value and worth.

The sale or exchange of goods or services has always been based on knowledge and those that lack sufficient knowledge typically are short changed in the exchange. The caveat of let the buyer beware was the first rule of commerce. As society became more complex and jobs or services became focused on only one or two specialties for each individual, the ability to know the value of things became more difficult. Further, the advent of the industrial revolution allowed for the formation of industries that became very efficient and competitive, whereby their best chance of selling their goods or services was to advertise the product to the consuming public.

Advertising became a way of selling such goods and services. Advertising was another area in which the caution let the buyer beware still ruled. Over time, the public and the courts grew tired and weary of inflated and outrageous claims of advantages, benefits, or results that never were true. The public began to insist on realistic claims and expectations in the advertising and good will built up with those companies and business that offered products or services that lived up to the hype found in the advertising.

The business good will was also based on the knowledge, service, and expertise provided by the sales force. Reputable businesses hired reputable and honest sales and marketing people. This is so because goodwill is the basis for new and continued business through either word of mouth, repeat customers, or recommendations. As such, the knowledge and expertise are utilized to improve goodwill directly with a client or customer and to separate one business from another.

In today's economy, the standard of excellence is to offer desired products or services with a sales staff that has the knowledgeable and training so as to help the client and answer any and all questions until the client is satisfied enough to make a purchase or obtain the services offered. Often, however, a potential client will call on the business to look around because there is a need or want that is felt, but not defined so the sales staff is left to assist the client to identify the need. At anytime during the visit or inquiry, the client often has a change of mind and may decide not to make a purchase or ask for more information, usually resulting in the client leaving and the business unable to make a sale or promote greater interest for future purchases. Often, the business does not understand what motivates a client to act as they do, so the business may continue with business strategies that are unsuccessful and even counter-productive.

As has been stated, commerce either develops new technologies or embraces those that can provide a competitive advantage or reach new customers or that can offer better service to potential or existing clients. One such technology is the internet. The internet is not necessarily a technology, but relies on computers to provide an information source readily accessible by anyone able to connect to the internet via a computer. The internet offers another commerce channel, among other things, that has expanded the reach of a local business or service across boundaries and borders to wherever anyone with a computer and access to the internet may be.

The internet provides access to websites that contain web pages of information. Commerce is conducted at many websites with goods or services described and illustrated for the benefit of the internet customer. Websites are usually designed for efficient loading of content on the client system as well as to provide helpful information in a logical and uncluttered manner. Unfortunately, most websites are set up much like catalogs where information is listed in categories and the internet customers browse through the catalog to find whatever it is that interests them.

Accordingly, what is needed is a business method or protocol of continually assessing a client's interest level and offering information suitable to that interest level yet also increasing the interest level to another level in a self directed or assisted manner.

### SUMMARY OF THE INVENTION

According to the present invention a method of progressively advancing an internet customer, as well as any type of retail customer in a retail setting, through a series of customer interest level stages towards a highest stage is disclosed. The ultimate highest stage typically is represented by the purchase or acquisitions of goods or services from the internet website provider or retail provider. Initially, the method includes generating a website of interest accessible by one or more internet customers and then within that website, providing an initial webpage of interest for the internet customer. The first webpage includes a display of segregated content representing a choice of multiple stages of progressively higher interest level found on a separate webpage of interest associated with each stage of higher interest level, where the initial webpage includes a link to each webpage of interest. Next, the method provides for directing the internet customer to a customer selected stage of higher interest level via the link to the associated webpage of interest found on the initial webpage. The associated webpage typically includes content satisfying the internet customer's higher interest level at the next stage. In the retail setting, the customer would be directed from one area of the store to another or actually be able to view on a computer system or other self directed search system levels of interest similar to that described with respect to the webpages of interest. This would allow both types of consumers to achieve an ultimate goal, which is to make a purchase or selection from goods or services offered by the location of commerce.

In an alternative embodiment, the method may be presented as a way of progressively advancing an internet client or retail client through a series of client interest level stages towards a highest stage of customer interest level where each stage is represented by an associated webpage or given area. In this method, the approach initially provides a list of resources on each of the webpages or at each area of interest within the store where each resource has a link to one or more webpages or provides directions towards the various stages that provide the content satisfying a specific market interest of the client. Each webpage details an interest different than those detailed on the other webpages as would the areas within the retail store would be different than other areas. Next, the method directs the internet client or the retail customer to an initial webpage of market interest having content related to a first level of interest. Once this is performed, the client is directed to a second webpage of market interest having content related to a second level of market interest higher than the first level of market interest. There may be more than two webpages or stages within the system. Lastly, the system uses each webpage or resource list to direct the internet client to a successive webpage having content of progressively increasing market interest to the internet client while including content for discouraging returning to a lower stage of market interest.

The method provides for displaying segregated content which represents categories of interest levels selected from the following group: the internet customer's wants, the internet customer's preferences, the internet customer's felt needs, the internet customer's actual needs, the internet customer's selection of a product or service consistent with the actual needs, and the internet customer's evaluation of his or her experience of visiting one or more webpages of interest. These types of segregated content are also provided in the retail setting. The method further includes evaluating an internet customer's experience with the webpage visit or the retail store visit to gauge the customer's satisfaction level through a questionnaire or survey so as to be able to better serve the customer and provide other goods and services desired by other customers. Further, the customer may be developed into what is called an enabled customer, which means they have a history and are valued as a preferred customer by the location of commerce in order to expand the business through such things as further communication to gauge the customer's wants and needs and to provide them with updates of sales and opportunities and new products. The enabled customers typically are viewed as a source of future customers through either referrals or recommendations.

Within the retail setting or the webpage various levels of interest are provided such as providing descriptions and details of the products or services offered by the location of commerce as well as to differentiate what the location of commerce offers over that of its competitors. Further, a stage or webpage that allows the customer to become a buyer is also provided.

Additional features and advantages of the invention will be apparent from the detailed description which follows, taken in conjunction with the accompanying drawings, which together illustrate, by way of example, features of the invention.

### BRIEF DESCRIPTION OF THE DRAWINGS

FIG. 1 illustrates an embodiment of the business method as contemplated in the present invention;

FIG. 2 depicts a flow diagram illustrating the interests and stages pursued as embodied in the present invention;

FIG. 3 illustrates a sample webpage of a first page in accordance with the present invention;

FIG. 4 illustrates a sample webpage representing a tour guide stage level;

FIG. 5 illustrates a webpage example depicting a salesman stage level; and

FIG. 6 illustrates a webpage example depicting an order taker stage of interest.

FIG. 7 provides a graphic representation of an advanced version of the MARC system presenting progressive stages of market interest correlated under columns of personification and functionality.

### DETAILED DESCRIPTION

Reference will now be made to the exemplary embodiments illustrated in the drawings, and specific language will be used herein to describe the same. It will nevertheless be understood that no limitation of the scope of the invention is thereby intended. Alterations and further modifications of the inventive features illustrated herein, and additional applications of the principles of the inventions as illustrated herein, which would occur to one skilled in the relevant art and having possession of this disclosure, are to be considered within the scope of the invention.

The present invention develops and implements a business or commerce strategy to improve helping customers learn about the products or services offered by a business and advance the customers to higher levels of market interest. The advancement is designed to encourage greater interest by providing more information that is specific and directed towards the customers' needs or wants as revealed to the customer. Stages or levels of interest are provided that advance a customer in a progressive fashion until the customer becomes a buyer of the goods or services offered by the business. Further, the method or strategy discourages the customer from retreating to a lower level of interest by offering the customer more information to assist the customer make a market decision.

Each opportunity to provide information to a customer or prospective customer is essentially advertising. Advertising is a message designed to change an attitude or behavior of the customer. The change may be from one who has no interest to buy, but becomes interested through the information from the ad. The change may be for one who wants something, but is not sure what it is exactly until reading the information from the ad. The change may be for one who knows what they want to buy, but not where or whose product to buy. Delivering these messages can be done in a store or online at a website through effective management of information in providing information to the client at the right time and in the right level to encourage greater interest or an actual purchase. One purpose of this invention is to provide information in an effective manner so that more interest is achieved in the customer and that customers who want to buy can make a purchase easily and quickly.

According to the present invention, a customer is an individual or entity that may or may not have an interest in the particular goods or services offered by the commercial establishment or location of commerce. The interest of the customer may increase to the point where the customer becomes a buyer of the goods or services of the location of commerce. A market decision is one where the customer acts to purchase a particular product or service from the location of commerce or simply to become a client of interest that the business establishment adds to its list of current and potential buyers. Thus, the list of contacts is expanded either through direct purchases by the customer or the customer requests more information in the future. This information may include, but is not limited to, offering catalog availability and ordering, contact or notification of specials lists sent either via currier mail or electronic mail (e-mail), notification of sales or specials being offered, or notification of specific products or services that become available, and being notified that a requested item or service may be available. Further, information may be obtained from the customers that can be beneficial to the business establishment. Such information can include surveys or questionnaires of the customers so that better service and product selection can be provided in the future.

Each step or stage of interest is not new in and of itself, but as presented in the outline of progressive stages, from lower to higher levels of interest, ideally to the point of becoming a buyer, with discouraging or inhibiting the customer from retreating to a lower interest level or stage, does provide an advancement over the art. The invention can be implemented in nearly all locations of commerce with the internet being one of the preferred channels of commerce. Websites having web pages are designed to provide information to the customer at varying levels of market interest the customer has when initially browsing the website. Each website includes a list of resources that allows the customer to jump or be led to another higher stage of market interest where greater and more specific information is offered. The information can include a list of products or services offered, a detailed description of one or more products or services, a comparison of what the competitors offer and the advantages, features, and value offered by the proprietor over that of the competitors, or buying policies such as warranties, returns, or other information helpful to both the consumer and the proprietors.

Even though the internet lends itself to the ease at which the invention urges a customer to seek more information and eventually make a buying decision, the method is equally applicable to brick and mortar businesses where the customer physically visits. In such a setting, the customer enters the business and is directed to a first stage that has general interest about the business as well as a list of content resources of where to find more information. The business can be set up to have segregated stages representing each interest level stage and further represented by a specific color. For example, the first stage provides basic information to help someone new to the business learn what is offered and where to go next for more information at different, progressively higher levels of interest.

Each stage is represented by a different color so that the consumer knows just from the color which stage he or she is in, thereby simplifying finding stages of interest within the business or even on the website. Additionally, each stage provides a path to one or more areas of interest. The stages are set up to direct the customer to a progressively higher interest level where more information is made available to the customer. The direction is provided as an urging recommendation or suggestion, while attempting to discourage the customer's retreating to a lower interest level. This discouraging process can be accomplished by having the customer walk or pass through the various stages before being able to exit or by purposely not providing links to stages at lower levels once the customer has moved to a higher level. It is not intended to force the customer to be in any specific stage and experience what is offered, but rather this process is calculated to let the customer advance quickly, even if it is just to get to the next stage.

Occasionally, a customer finds the business or website and really has no interest in what is offered at the location of commerce. In these instances, the visitor is really a loiterer, meaning someone not having any real interest and would be ill-suited to guiding through the location. Thus, in these cases, the loiterer is redirected or gently persuaded that they should go somewhere else. For a store, a greeter may be employed to help the loiterer determine whether there is any interest in the goods or services offered and helping the customer find a store or business consistent with the loiterer's needs. On a webpage, the visitor is allowed to click to a more suitable website without going deeper into the site if it would be of no benefit to the visitor.

The business approach can also be laid out to achieve specific stages or objectives representing important phases in the progression of a customer to the point of becoming a buyer and even beyond. The first phase is to migrate a customer to become a buyer or future buyer. This is accomplished by directing the customer from one interest level to another, higher level. The next phase is the acquisition of the customer as a buyer or future buyer. This is when the customer buys a product or service or shows such significant interest that future follow up is important to help the customer decide whether a purchase is possible at that time. This is also where a future buyer can be placed on mailing or catalog lists, which serve to provide the customer with more information at a later time should the customer wish then to make a purchase.

The next phase is the retention phase. This is accomplished by servicing the buyer after the purchase is made to convert the buyer into an “engaged” buyer. This means the buyer is groomed to make future purchases hopefully on a regular basis. The final phase is capitalizing on the engaged buyer. This builds on the retention phase of where the buyer is now a repeat and satisfied customer. This is also where the buyer can be courted to provide new leads of other potential customers such as referrals and ideas for new products or services desired by the buyers.

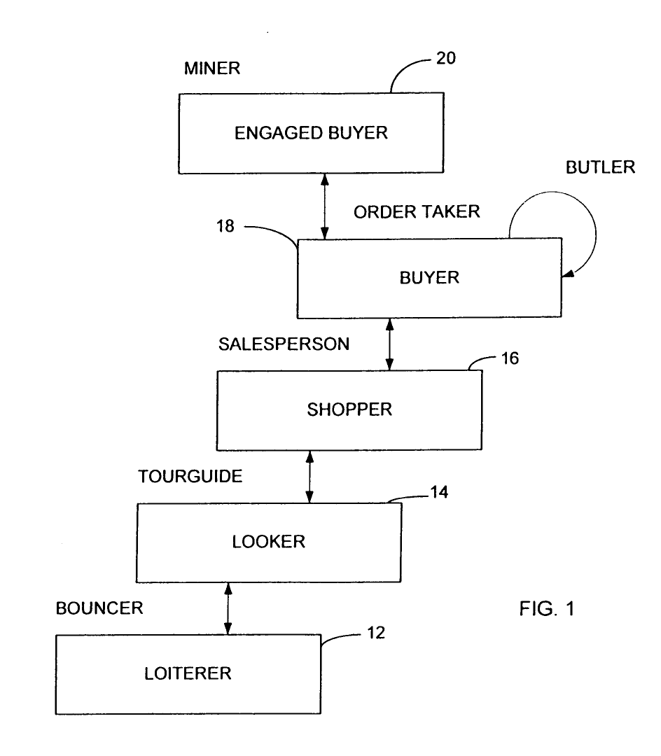

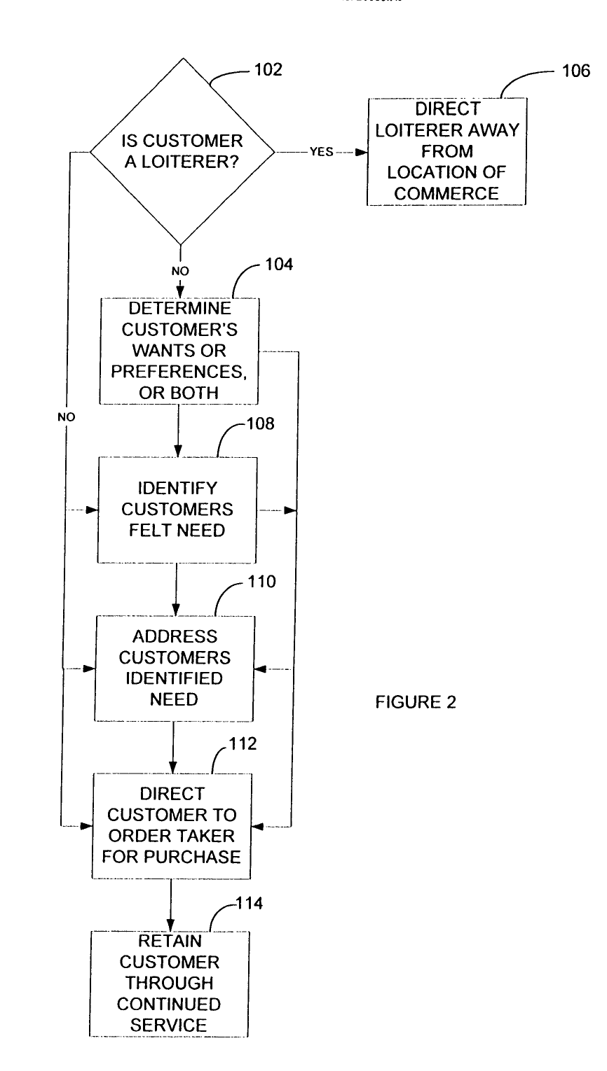

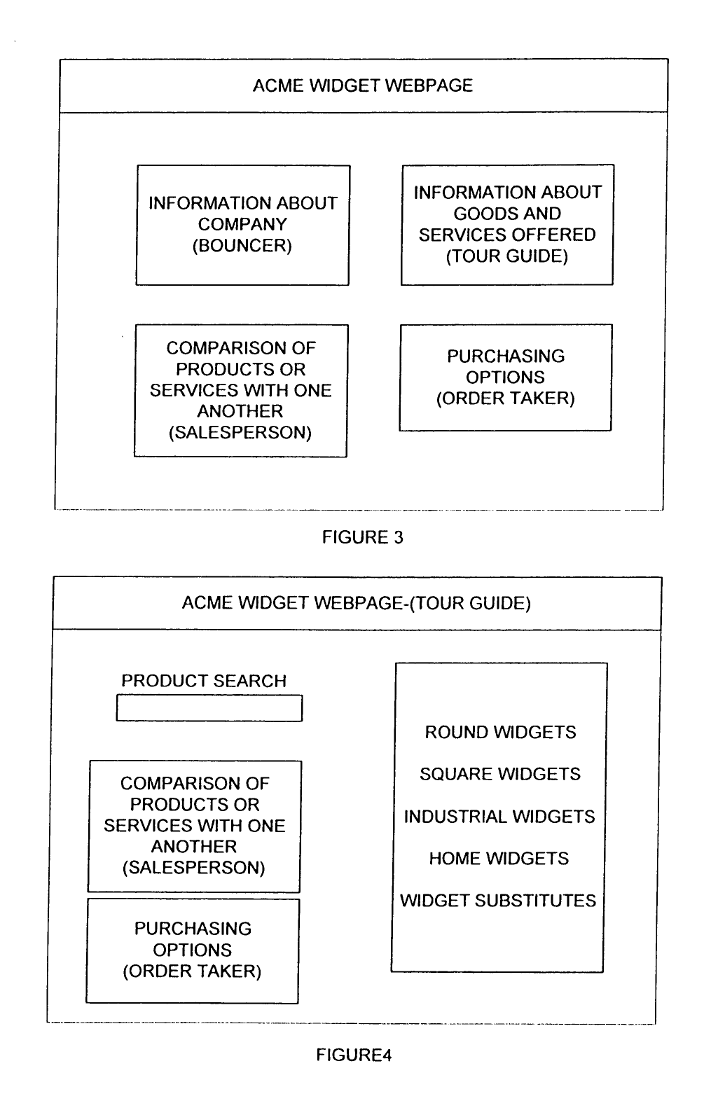

The migration phase evolves prospects or customers from raw leads or first time browsers to ultimate buyers and is illustrated in the flow diagrams of FIGS. 1 and 2. Through this phase a “Bouncer” may be implemented whose function is to eliminate non-buyers or loiterers 12, shown in block 102 of FIG. 2, from the business database of actual purchasers and legitimate leads. The bouncer also directs prospects into the correct database and to a next level of interest suitable to the prospect's expressed need or wants as shown in block 104; otherwise, the bouncer redirects the loiterer away from the location of commerce in a helpful way, if possible. FIGS. 3-6 illustrate various views of webpage embodiments of the present invention with Figure depicting a first page listing a variety of resources to assist and interest a prospective customer or loiterer.

At a next level, a “Tour Guide” is provided whose function is to differentiate the services or products of the business from those of the competition in order to help a looker 14. Thus, the prospect or customer is directed from a loiterer stage 12 to a looker stage 14, where the prospect has expressed selected wants or preferences offered at the business (block 104). The Tour Guide builds on the customer's wants and preferences until they become felt needs, as shown in block 110. These needs may be built on lifestyles or interests. The Tour Guide uses product demonstrations as a form of “tour” to generate a recognition of such needs. The Tour Guide also spends time describing or explaining services to the customer or looker. The purchase process may also be described and shown at this time to help the looker. Evaluations can be made either by a trained Tour Guide, or offered in a self-directed process. These evaluations can include what-if scenarios of financing, product advantages, services offered, and the like. FIG. 4 illustrates a sample webpage embodiment at the Tour Guide stage.

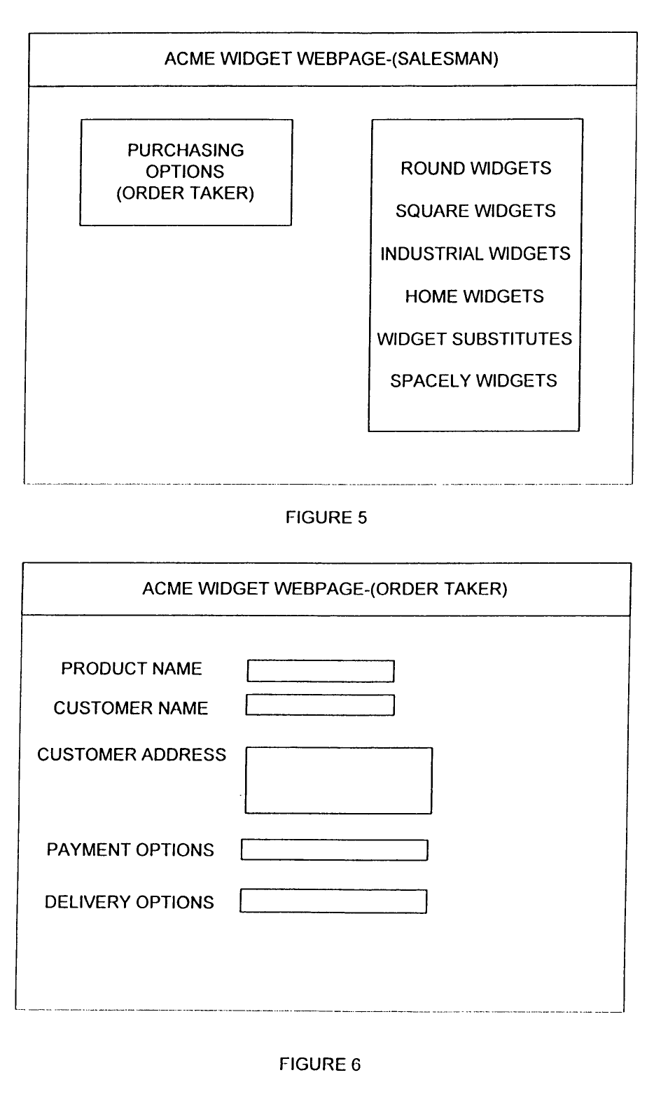

The next level, a “Salesperson,” is provided whose function is to assist the customer in differentiating the product features of one product from like products offered by the business or by competitors, and to explain benefits derived from such features. This also falls within the actions of block 110. Next, the looker 14 is then directed to a shopper stage 16 where the shopper 16 is driven by felt needs. Online and in an actual business, expert product selection systems are provided that aid the customer to turn into a buyer. These systems present the purchasing information needed by the customer effectively, efficiently, and accurately as possible. The selection system can also offer recommendations based on criteria supplied by the customer during a product or service search performed at the website or on an onsite computer search system. The search system and website can offer self-service purchases that can be delivered directly to the buyer or offered for pick up at a local store convenient to the buyer. FIG. 5 illustrates a sample webpage embodiment at the Salesman stage.

The acquisition phase is where the customer has evolved into a buyer 18 and an “Order Taker” is provided whose function is to take the order of those customers who are ready to buy any good or service as shown in block 112. At this point, the needs of the customer are identified and fulfilled by the Order Taker. The Order Taker enables the customer to make an immediate purchase or decision to purchase. This is intended to satisfy the need identified in the buyer shown in block 108. This is also the stage where a long-term, possibly life-long, customer relationship is established. The Order Taker can utilize standard e-commerce tools to provide price, selection, payment options, delivery options, return policies and the like. The Order Taker can also provide product or service search functionality complementing the search service offered in the Tour Guide. Quote requests and purchase requests can be generated and executed as well through the Order Taker. FIG. 6 illustrates a sample webpage embodiment at the Order Taker stage.

The retention phase, as shown in block 114, advances buyers 18 into engaged buyers 20 by providing superior service that is valued and desired by the buyer and that builds customer-loyalty and good will. A “Butler” is provided at this stage, whose function is to provide the buyer such services and information. These services include, but are not limited to, preferred customer status, changing orders, checking order status, confirming order fulfillment, buyer account status, accessory cross-selling, and the use of surveys to gauge buyer satisfaction and other wants or needs.

The services can be done on an as-needed basis or on a cyclic basis, such as monthly, quarterly, or so. Repeated and regular communications with the customer are emphasized to instill goodwill with and sell quality of service to both prospective and current customers. The goodwill sells the customer on repeat business and provides referrals either directly or via word of mouth. The acquisition of more and more customers builds a community of buyers that support and sustain the business and provide additional business opportunities and business contacts. An executive level of contact is also provided that yields referrals and repeat business from the buyer, thus engaging the buyer in the success in the business through satisfaction and loyalty. Preferred customer status applies to buyers who become engaged buyers, which can be achieved typically by either purchase history, paid membership, or promotional limited time only trial basis, but is not limited thereto.

The capitalization phase evolves the engaged buyer 20 to greater engagement with the business. A “Miner” is provided whose function is to transform new and existing satisfied buyers into new opportunities. The Miner may also be at the executive level of the business. The Miner can track when ad or marketing campaigns to sell given products or services are successful or unsuccessful, which products sell and which do not, so that these matters can be improved for greater sales growth and customer satisfaction.

These phases come together in an approach that is can be referred to as “MARC”, for Migration, Acquisition, Retention, and Capitalization. This perspective and summary is far more than a mere acronym. Indeed, the four stages of migration, acquisition, retention and capitalization constitute a business protocol that embodies the desired continuity within a free enterprise market. This constitutes a method of doing business in the purest form. It comprehends the transition from initial exposure of a customer to a business, to the ultimate association with that business as a loyal member of the customer family, actively engaged in voluntarily advancing the interests of the business. In a sense, it unifies fragments and isolated business perspectives currently spread across the marketplace into a simple and useful methodology that increases business success by focusing product promotion and education within the progressive stages represented by MARC.

The location of a business is set up to include sign posts, imagery, navigation and other tools, to assist the interested consumer to continually evolve toward a buyer stage of interest. Logos are utilized to serve various purposes. Many logos serve only as an identifier or as a Bouncer. Colors are utilized to maximize the impact of the logos and other elements found within the location of commerce. In one example, the identifier logos are red. Strategic logos, which may be orange, are also utilized to communicate such things as lifestyle benefits, experience, stability and other Tour Guide benefits. Imagery or graphics is intended to be used extensively and liberally to aid and complement the Tour Guide benefits and would also be colored with orange. The Order Taker would be green for color identification. Such graphics include photographs, illustrations, and other supporting graphics.

It is intended that product imagery be used to encourage customer migration from the Looker to the Customer to the Buyer phases. Thus, the color orange would transition to yellow, for example. The color coding is selected with the intended audience in mind and is prepared so that consistent paths are provided throughout the location of commerce. The colors selected above are exemplary and not intended to be limiting; other color schemes are also possible. The color scheme also helps the store employees and managers to quickly identify where they are and what role they may play in assisting a customer as well as to help them direct the customers to the appropriate stage. Further, tools are selected to appeal to the different participants such as the lookers, the shoppers, the buyers, the consumers, and the engaged buyers.

Additional information about the MARC system of market building methods and examples is provided in the parent provisional application, which is hereby incorporated by reference with all of its attached materials under the APPENDIX.

The MARC system can be applied to, but not limited to, the following areas of interest: Addiction and Recovery, Advertising, Diplomacy, Graphic Design, Marketing, Marketing Communications (MarCom), Public Relations, Sales Consulting, Sales Training, Customer Service Consulting, Customer Service Training, Personal & Corporate Financial Planning, Organizational Development Consulting, Instructional Design & Curriculum Development, Instruction, Facilitation, Coaching & Mentoring, Software Usability Analysis & Design, Software Development Project Management, Executive Training and Development, Executive Outplacement, Your Job Search, Human Resource Management, Application User Interface Development and Design, Credit and Collections, Fundraising, Event Planning, Supply Chain Management, Customer Relationship Management, Collective Bargaining, Mediation & Conflict Resolution, Jury Persuasion, Retail Store Floor Layout Planning, Retail Loss Prevention, Public Space Planning, Multi Level and Direct Sales Marketing, Manufacturing, Marriage and Family Therapy, Patient Communications for Medical Practitioners, Personal Financial Management & Investment, Political Campaign Management.

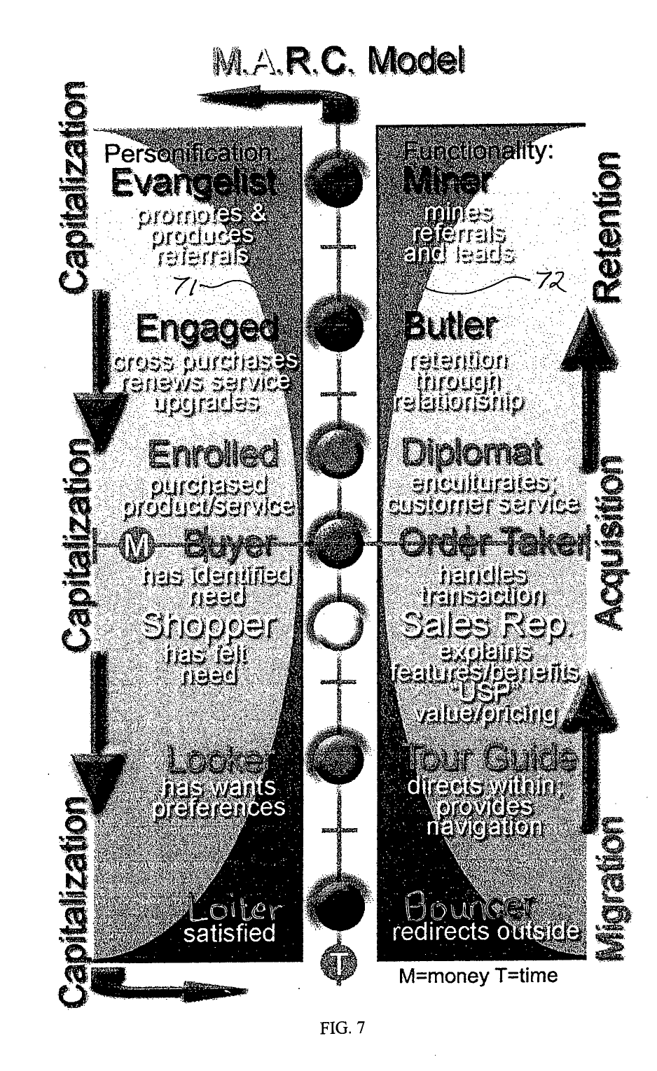

The previously discussed Internet version can be generalized for other marketing applications as set forth above in accordance with the illustration of FIG. 7. This embodiment shows a chart adapted to predict likelihood of marketing success using the MARC factors within variable of time, expense (money) and numbers of persons in the target group. In other words, one skilled in the art can use this chart to qualitatively evaluate the ability of a marketing plan to reach various levels of interest as shown within the figure. By spending more time in the project, the vertical height of the chart increases, illustrating an increase in likelihood of response. Similarly, by investing more money (shown along the horizontal axis) greater results will be achieve as represented by the lateral extension of the cone represented by lines 71 and 72. Finally, increasing the numbers of participants (N) to be exposed to the marketing effort, provides variation to the performance of this chart. Both the shape and the area of the conjoined cones (or N) represents a predictable graphic expression of the relationship of these parameters of time, money and target population (N).

A further modification of this latter embodiment is the addition of the “Diplomat” level of interest. This factor, in combination with the “Butler” component represents the customer relationship factor-both positive and negative. For example, the Diplomat functionality deals with the need for overcoming negative experiences in the business-customer relationships. The ability of the business to turn the customer attitude from anger and frustration to appreciation is important in the progressive development of a customer toward the ultimate goal of becoming a promoter or “Evangelist”. Similarly, on the positive side, retention of customers by providing extra, unexpected services is determinative in realizing the ultimate conversion of a customer to an advocate. In the MARC format, the Diplomat functionality is represented by the “Engaged” personification, leading to cross purchasing activity, renewal of services and purchase of upgrades. By implementing this progressive evolution from Loiterer to Evangelist, and then creating a geometric expansion by virtue of multiple contacts from each Evangelist promoter, the development of capitalization and growth of the business is significantly enhanced. Again, this is accomplished by the repetition of the migration, acquisition and retention methodology embodied in the MARC method.

This later embodiment is represented conceptually by the following general description of the invention. Specifically, the invention is a method of progressively advancing a potential customer through a series of customer interest level stages toward a stage of becoming an advocate who promotes a given product or service for which he had been merely a customer, comprising: a) generating promotional material of interest and accessible to the customer; b) within the material, providing initial content representing a choice of multiple stages of progressively higher interest level and segregated within the material to allow the customer to gravitate toward his current level of interest, said initial content including entry material associated with stages of higher interest level; and c) directing the customer from his current level of interest to a customer-selected stage of higher interest level via at least one category of the entry material associated with the higher interest levels, wherein the material includes content satisfying the internet customer's higher interest level progressively toward the stage of becoming the advocate. In addition, the method can be modified wherein the display of segregated content represents a category interest level selected from the group consisting of the customer's wants, the customer's preferences, the customer's felt needs, the customer's actual needs, the customer's selection of a product or service consistent with the actual needs, a customer purchase of the product or service; cross purchasing activity of related products or services, and promotion of the product or service to others.

Other variations of the invention include a version wherein the customer is provided with services responsive to the selected category of entry material corresponding to an advancement function designed to advance the customer to a higher level of interest, selected from the group consisting of (i) directing the customer from customer wants to customer preferences, (ii) directing the customer from customer preferences to customer felt needs; (iii) directing the customer to identified needs; directing the customer to an purchase processing station; directing a customer to a service operation for resolving negative experiences of the customer; directing the customer to a positive relationship activity; and directing the customer to a referral mechanism for generating other customers. Also, the functions of directing customers to progressive levels of interest may be formed as part of a model as shown in FIG. 7, incorporating variable amounts of time to be applied within the functions and yielding a prediction of likely results of marketing activity. Alternatively or additionally, the functions of directing customers to progressive levels of interest may be formed as part of a model incorporating variable amounts of money to be applied within the functions and yielding a prediction of likely results of marketing activity. These may be structured with respect to the functions as part of a chart with time and money amounts indicated along different directions within the chart. Specifically, the chart with the money and time amounts may be shown along x and y coordinates as illustrated in FIG. 7. Finally, the method can include providing a factor that incorporates a variable quantity of potential customers as an element in predicting the marketing results.

It is to be understood that the above-referenced arrangements are only illustrative of the application for the principles of the present invention. Numerous modifications and alternative arrangements can be devised without departing from the spirit and scope of the present invention. While the present invention has been shown in the drawings and fully described above with particularity and detail in connection with what is presently deemed to be the most practical and preferred embodiment(s) of the invention, it will be apparent to those of ordinary skill in the art that numerous modifications can be made without departing from the principles and concepts of the invention as set forth herein.

Claims of the present invention are as follows:

1. A method of progressively advancing an internet customer through a series of customer interest level stages towards a highest stage, comprising:
a) generating a website of interest accessible by one or more internet customers;
b) within the website, providing an initial webpage of interest for the internet customer, wherein the first webpage includes a display of segregated content representing a choice of multiple stages of progressively higher interest level found on a separate webpage of interest associated with each stage of higher interest level, the initial webpage including a link to each webpage of interest; and
c) directing the internet customer to a customer-selected stage of higher interest level via the link to the associated webpage of interest found on the initial webpage, wherein the associated webpage includes content satisfying the internet customer's higher interest level at the next stage.

2. The method according to claim 1 wherein the display of segregated content represents a category interest level selected from the following group: the internet customer's wants, the internet customer's preferences, the internet customer's felt needs, the internet customer's actual needs, the internet customer's selection of a product or service consistent with the actual needs, and the internet customer's evaluation of his or her experience of visiting one or more webpages of interest.

3. The method according to claim 2 wherein the internet customer's selection content comprises the step of providing a link to an order taker webpage allowing the internet customer to obtain the selected product or service.

4. The method according to claim 1 also comprising the step of directing an internet loiterer outside the website.

5. The method according to claim 2 wherein the internet customer's evaluation content comprises the step of providing a link to a survey webpage where the customer's satisfaction level is evaluated through a questionnaire.

6. The method according to claim 5 further comprising the step of using the customer evaluation to improve the website to increase customer's satisfaction in future website visits.

7. The method according to claim 2 wherein the customer's evaluation content comprises the step of securing referrals of other potential internet customers.

8. The method according to claim 2 also comprising the step of providing on at least one of the webpages of interest a discussion of features and benefits of at least one product or service available to the internet customer through the website.

9. The method according to claim 2 also comprising the step of providing on at least one of the webpages of interest, a discussion differentiating the products or services offered at the website from competitors offering similar products or services.

10. The method according to claim 1 further comprising the step of providing a webpage of interest where the internet customer can either check whether an order has been fulfilled, check a status of the order, or change the order.

11. A method of progressively advancing an internet client through a series of client interest level stages towards a highest stage of customer interest level, each stage represented by an associated webpage, comprising:
a) providing a list of resources on each of the webpages, each resource having a link to one or more webpages providing content satisfying a specific market interest the client may have, wherein each webpage details an interest different than those detailed on the other webpages;
b) directing the internet client to an initial webpage of market interest having content related to a first level of interest;
c) directing the internet client to a second webpage of market interest having content related to a second level of market interest higher than the first level of market interest; and
c) using each webpage or resource list to direct the internet client to a successive webpage having content of progressively increasing market interest to the internet client while including content for discouraging returning to a lower stage of market interest.

12. A method of progressively advancing a customer through a series of custom market interest level stages towards a highest stage, comprising:
a) providing a location of commerce offering products or services, or both, and accessible by one or more clients;
b) within the location of commerce, providing an initial stage of market interest for the client, wherein the initial stage includes a display of segregated content representing a choice of multiple stages of progressively higher market interest level found at separate areas within the location of commerce, each area being associated with one stage of higher market interest level, the initial stage including a path to each area of interest;
c) migrating the client to a customer-selected stage of higher market interest level via information offered at the initial stage of market interest and directing the client to the area associated with the customer-selected stage while providing content discouraging returning to a stage of lower market interest, wherein the associated area includes content satisfying the internet customer's higher market interest level as selected;
d) acquiring the client as a buyer at the location of commerce through one of the stages of market interest;
e) retaining the buyer as an engaged customer by providing follow up information or making directed inquiries related to market interest; and
f) capitalizing on the acquired buyer by encouraging repeat business with the location of commerce or securing referrals from the acquired buyer.

13. The method according to claim 12 wherein the display of segregated content represents market focus for each stage of higher market interest level that includes at least three selected from the following group: the client's wants, the client's preferences, the client's felt needs, the client's actual needs, the client's selection of a product or service consistent with the actual needs, and the client's evaluation of his or her experience of visiting one or more areas of interest.

14. The method according to claim 13 wherein the client's selection content comprises the step of providing an encounter with an order taker allowing the client to obtain the selected product or service.

15. The method according to claim 12 also comprising the step of directing a non-client loiterer outside the location of commerce to the benefit of the non-client loiterer.

16. The method according to claim 13 wherein the client's evaluation content comprises the step of providing a survey where the client's satisfaction level is evaluated through a questionnaire.

17. The method according to claim 13 further comprising the step of using the client evaluation to improve the location of commerce to increase the client's satisfaction in future visits.

18. The method according to claim 12 wherein the migrating step also comprises the step of providing at least one of the areas of market interest a discussion of features and benefits of at least one product or service available to the client offered by the location of commerce.

19. The method according to claim 12 wherein the migrating step also comprises the step of providing at one of the areas of market interest, a discussion differentiating the products or services offered at the location of commerce from competitors offering similar products or services.

20. The method according to claim 12 wherein the retaining step further comprises the step of providing an area of market interest where the client can either check whether an order has been fulfilled, check a status of the order, or change the order.

21. A method of progressively advancing a client through a series of client interest level stages towards a highest stage of client market interest level, each stage represented by an associated area of market interest, comprising:
a) providing a list of resources on at least one of the areas of market interest, each resource guiding the client to one or more areas of market interest that provide content satisfying a specific market interest the client may have, wherein each area of market interest details a market interest different than those detailed at the other areas of market interest;
b) directing the client to an initial area of market interest having content related to an initial level of market interest;
c) directing the client to a second area of market interest having content related to a second level of market interest higher than the initial level of market interest; and
d) using each area of market interest or resource list to direct the client to a successive area of market interest having content of progressive market interest to the client while including content for discouraging returning to a lower stage of market interest.

22. The method according to claim 1, 11, 12, or 21 wherein each stage of interest is assigned a unique color code.

23. A method of progressively advancing a potential customer through a series of customer interest level stages toward a stage of becoming an advocate who promotes a given product or service for which he had been merely a customer, comprising:
a) generating promotional material of interest and accessible to the customer;
b) within the material, providing initial content representing a choice of multiple stages of progressively higher interest level and segregated within the material to allow the customer to gravitate toward his current level of interest, said initial content including entry material associated with stages of higher interest level; and
c) directing the customer from his current level of interest to a customer-selected stage of higher interest level via at least one category of the entry material associated with the higher interest levels, wherein the material includes content satisfying the internet customer's higher interest level progressively toward the stage of becoming the advocate.

24. The method according to example 23 wherein the display of segregated content represents a category interest level selected from the group consisting of the customer's wants, the customer's preferences, the customer's felt needs, the customer's actual needs, the customer's selection of a product or service consistent with the actual needs, a customer purchase of the product or service; cross purchasing activity of related products or services, and promotion of the product or service to others.

25. The method according to claim 24, wherein the customer is provided with services responsive to the selected category of entry material corresponding to an advancement function designed to advance the customer to a higher level of interest, selected from the group consisting of (i) directing the customer from customer wants to customer preferences, (ii) directing the customer from customer preferences to customer felt needs; (iii) directing the customer to identified needs; directing the customer to an purchase processing station; directing a customer to a service operation for resolving negative experiences of the customer; directing the customer to a positive relationship activity; and directing the customer to a referral mechanism for generating other customers.

26. A method as defined in claim 25, wherein the functions of directing customers to progressive levels of interest are formed as part of a model incorporating variable amounts of time to be applied within the functions and yielding a prediction of likely results of marketing activity.

27. A method as defined in claim 25, wherein the functions of directing customers to progressive levels of interest are formed as part of a model incorporating variable amounts of money to be applied within the functions and yielding a prediction of likely results of marketing activity.

28. A method as defined in claim 25, wherein the functions of directing customers to progressive levels of interest are formed as part of a model incorporating variable amounts of time and money to be applied within the functions and yielding a prediction of likely results of marketing activity.

29. A method for projecting likely results of a market activity in accordance with claim 28, wherein the time and money amounts are structured with respect to the functions as part of a chart with time and money amounts indicated along different directions within the chart.

30. A method as defined in claim 29, comprising structuring the chart with the money and time amounts shown along x and y coordinates.

31. A method as defined in claim 25, including providing a factor that incorporates a variable quantity of potential customers as an element in predicting the marketing results.
